(19) United States
(12) Patent Application Publication
(10) Pub. No.: US 2026/0142511 A1
(43) Pub. Date: May 21, 2026

(54) ROTOR AND SWITCHED RELUCTANCE MOTOR

(71) Applicant: ISUZU MOTORS LIMITED, Yokohama-shi (JP)

(72) Inventors: Yusuke TAKAHASHI, Fujisawa-shi, Kanagawa (JP); Taku HONDA, Fujisawa-shi (JP); Noboru NIGUCHI, Osaka (JP); Yasuhisa KODAMA, Nakatsugawa-shi (JP)

(21) Appl. No.: 19/361,051

(22) Filed: Oct. 17, 2025

(30) Foreign Application Priority Data
Nov. 18, 2024 (JP) 2024-200661

(51) Int. Cl. H02K 1/24; H02K 1/14

(52) U.S. Cl. CPC H02K 1/246; H02K 1/146

(57) ABSTRACT

A rotor includes: a rotor core rotatably disposed about a rotating shaft and formed of a first magnetic material; a plurality of first salient poles formed of the first magnetic material and formed on an outer peripheral surface of the rotor core at predetermined intervals in a circumferential direction of the rotor core; a plurality of second salient poles provided radially outside the plurality of first salient poles of the rotor core and formed of a second magnetic material having lower iron loss than the first magnetic material; and a stopper, formed of an insulating material, that is engaged with the first salient poles and the second salient poles.

### CROSS-REFERENCE TO RELATED APPLICATIONS

The present application claims priority to Japanese Patent Application number 2024-200661, filed on November 18, 2024, contents of which are incorporated herein by reference in its entirety.

### BACKGROUND OF THE INVENTION

The present disclosure relates to a rotor and a switched reluctance motor. A conventional switched reluctance motor (hereinafter referred to as "SR motor") includes a stator formed in a cylindrical shape by stacking annular electromagnetic steel sheets, and a rotor, which is disposed radially inward of the stator and also formed in a cylindrical shape. The stator has a plurality of stator teeth formed on its inner periphery, and the rotor has a plurality of rotor teeth formed on its outer periphery (for example, Japanese Unexamined Patent Application Publication No. 2018-186592).

The SR motor generates torque as the rotor rotates in a manner that reduces the magnetic reluctance associated with the coil corresponding to the excited phase among the coils wound around the stator teeth. Since the polarity of each stator tooth in the magnetized state is fixed, the polarity of each rotor tooth changes in accordance with the polarity of the stator tooth adjacent to the rotor tooth. As a result, the rotor experiences increased hysteresis loss (so-called iron loss). To address this, one measure is to form the rotor using materials with low iron loss; however, such materials tend to increase cost or reduce torque density.

### BRIEF SUMMARY OF THE INVENTION

The present disclosure has been made in view of these points, and its object is to reduce iron loss in the rotor while suppressing increases in cost and decreases in torque density.

A rotor according to a first aspect of the present disclosure includes: a rotor core rotatably disposed about a rotating shaft and formed of a first magnetic material; a plurality of first salient poles formed of the first magnetic material and formed on an outer peripheral surface of the rotor core at predetermined intervals in a circumferential direction of the rotor core; a plurality of second salient poles provided radially outside the plurality of first salient poles of the rotor core and formed of a second magnetic material having lower iron loss than the first magnetic material; and a stopper, formed of an insulating material, that is engaged with the first salient poles and the second salient poles.

A switched reluctance motor according to a second aspect of the present disclosure includes: a rotor; and a stator, wherein the rotor includes: a rotor core rotatably disposed about a rotating shaft and formed of a first magnetic material; a plurality of first salient poles formed of the first magnetic material and formed on an outer peripheral surface of the rotor core at a predetermined first interval in a circumferential direction of the rotor core; a plurality of second salient poles provided radially outside the plurality of first salient poles of the rotor core and formed of a second magnetic material having lower iron loss than the first magnetic material; and a stopper, formed of an insulating material, that is engaged with the first salient poles and the second salient poles, and the stator includes: a stator core disposed on an outer diameter side of the rotor; and tooth portions that are formed on an inner peripheral surface of the stator core at a predetermined second interval in the circumferential direction of the stator core, each of the tooth portions having a coil of one phase among coils of a plurality of phases wound therearound.

### BRIEF DESCRIPTION OF THE DRAWINGS

FIG. 1 is a diagram showing an overview of a motor 1.

FIG. 2 is an enlarged view of a portion P of the cross-sectional view of a rotor 3.

FIG. 3 is a view showing a stopper 23 filling a space between adjacent salient poles 20.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### An overview of a motor 1

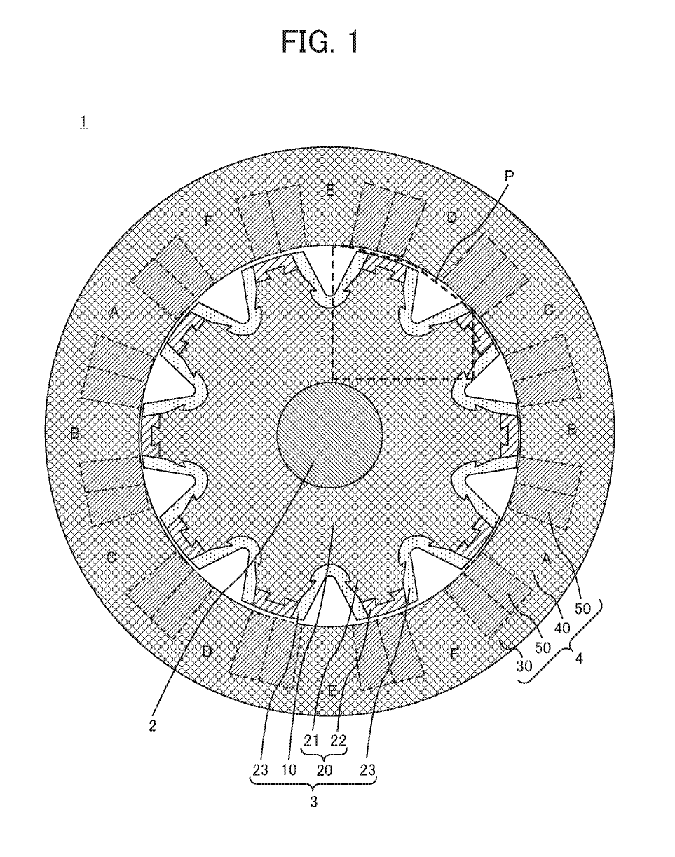

FIG. 1 is a diagram showing an overview of a motor 1. FIG. 1 is a cross-sectional view taken along a plane perpendicular to the axial direction of a rotating shaft 2 of the motor 1. The motor 1 is a switched reluctance motor (SR motor), and includes the rotating shaft 2, a rotor 3, and a stator 4.

The rotor 3 is a rotor located outside the rotating shaft 2 and inside the stator 4, and includes a rotor core 10, a plurality of salient poles 20, and a plurality of stoppers 23. In FIG. 1, only one salient pole 20 among the plurality of salient poles 20 is denoted by a reference numeral, and among the plurality of stoppers 23, only the stoppers 23 that are in contact with the salient pole 20 denoted by the reference numeral are denoted by a reference numeral. The rotor core 10 is rotatably mounted in the rotation direction (circumferential direction) of the rotating shaft 2, and is formed in a cylindrical shape by stacking, for example, annular magnetic material in the axial direction. The salient pole 20 has a first salient pole 21 and a second salient pole 22, and protrudes radially outward from the outer periphery of the rotor core 10. The salient pole 20 is formed of a magnetic material, and the first salient pole 21 is formed integrally with the rotor core 10. The stopper 23 is formed of an insulation material and is engaged the first salient pole 21 and the second salient pole 22.

The stator 4 is a stator located outside the rotor 3, and includes a stator core 30, a plurality of tooth portions 40, and a plurality of coils 50. In FIG. 1, only one tooth portion 40 among the plurality of tooth portions 40 and only one coil 50 among the plurality of coils 50 are denoted by reference numerals.

The stator core 30 is disposed outside the rotor 3, and is formed in a cylindrical shape by stacking, for example, annular magnetic material in the axial direction. The tooth portions 40 are formed of a magnetic material, and are formed on the inner peripheral surface of the stator core 30 at predetermined intervals in the circumferential direction of the stator core 30. The predetermined interval refers to an interval at which the plurality of tooth portions 40 are formed at equal intervals in the circumferential direction. A coil 50 of one phase among the coils 50 of a plurality of phases is wound around each tooth portion 40. In FIG. 1, six phases, namely Phase A, Phase B, Phase C, Phase D, Phase E, and Phase F, are shown as the plurality of phases, and a coil 50 of Phase A is wound around the tooth portion 40 denoted by the reference numeral.

The motor 1 generates torque by rotating the rotor 3 in a manner that reduces the magnetic reluctance associated with the coil 50 corresponding to the excited phase (the phase with high magnetic reluctance) among the coils 50 wound around the tooth portions 40. In the motor 1, a drive circuit (not shown) excites the phase with high magnetic reluctance, which changes as the rotor 3 rotates, thereby allowing the rotor 3 to continue rotating.

In the motor 1, since an alternating magnetic field is generated in the rotor 3 and the stator 4 by the rotation of the rotor 3, iron losses (hysteresis loss, eddy current loss) occur. In the stator 4, since the polarity (S pole or N pole) of each tooth portion 40 is fixed, hysteresis loss occurs due to repetition of a non-magnetized state and a magnetized state. On the other hand, in the rotor 3, the polarities of the salient poles 20 changes in response to the polarities of the adjacent tooth portions 40, resulting in hysteresis loss caused by repeated S-pole and N-pole magnetization states. This hysteresis loss is greater than the hysteresis loss that occurs in the stator 4. Further, since the frequency of the alternating magnetic field of the rotor 3 is higher than the frequency of the alternating magnetic field of the stator 4, the iron loss of the rotor 3 is greater than the iron loss of the stator 4.

To address the above, one measure is to form the rotor 3 from a low iron-loss material with small iron loss, such as a thin silicon steel sheet (e.g., with a thickness of 100 μm or less), an amorphous crystalline metal, or a powder material in which the surface of each metal particle is coated with a resin. However, thin silicon steel sheets and amorphous crystalline metals are more costly than the conventional silicon steel sheets (which are not thin) used to form the conventional rotor 3 and stator 4. In addition, a rotor 3 formed of powder material lacks sufficient strength against the forces generated during rotation, thereby making it difficult to increase a rotation speed of the rotor 3. Furthermore, since low iron-loss materials have a lower saturation magnetic flux density than conventional materials, they may thereby reduce torque density.

Therefore, the rotor 3 includes a first salient pole 21 formed on the outer peripheral surface of the rotor core 10 and formed of a conventional material, and a second salient pole 22 provided radially outside the first salient pole of the rotor core 10 and formed of a low iron-loss material. With such a configuration, since the rotor 3 has the second salient pole 22 formed of the low iron-loss material at a position where the iron loss is large (a position where the tooth portions 40 and the salient poles 20 are close to each other), the iron loss can be suppressed. Furthermore, in the rotor 3, since the rotor core 10 and the first salient pole 21 are formed using conventional materials, it is possible to suppress increases in cost and decreases in torque density as compared with a case where the entire rotor 3 is formed of the low iron-loss material. In addition, since the stopper 23 engages the first salient pole 21 and the second salient pole 22, the second salient pole 22 can be prevented from being separated from the first salient pole 21 even when centrifugal force from the rotation of the rotor 3 and magnetic stress act on the second salient pole 22. Hereinafter, the configuration of the rotor 3 will be described in detail.

### Configuration of the rotor 3

As shown in FIG. 1, the rotor 3 includes the rotor core 10, the plurality of salient poles 20, and the plurality of stoppers 23. Each salient pole 20 has the first salient pole 21 and the second salient pole 22. The stopper 23 is provided between the adjacent salient poles 20. The rotor core 10 is rotatably disposed about the rotating shaft 2, and is formed of a first magnetic material. The first magnetic material is, for example, a conventional material such as a silicon steel sheet that is not thin.

The first salient poles 21 are formed of the first magnetic material, and are formed on the outer peripheral surface of the rotor core 10 at predetermined intervals in the circumferential direction of the rotor core 10. The predetermined interval refers to an interval at which the plurality of first salient poles 21 are formed at equal intervals in the circumferential direction of the rotor core 10. The first salient pole 21 protrudes radially outward from the outer peripheral surface of the rotor core 10, and wedge-shaped convex portions are formed on a surface along the radial direction and a top surface thereof. The rotor core 10 and the first salient pole 21 are integrally formed. As described above, by including the rotor core 10 and the first salient poles 21 formed of the first magnetic material, the rotor 3 can suppress increases in cost and decreases in torque density.

The second salient poles 22 are provided radially outside the first salient pole 21 of the rotor core 10, and are formed of a second magnetic material having lower iron loss than the first magnetic material. The second magnetic material is a low iron-loss material such as the thin silicon steel sheet, the amorphous crystalline metal, or the powder material. The second salient pole 22 is in contact with the top surface of the first salient pole 21, and a wedge-shaped concave portion is formed on the surface in contact with the top surface. Since the second salient poles 22 are configured in this manner, the rotor 3 can be provided with the second salient poles 22 formed of the low iron-loss material at positions where the tooth portions 40 and the salient poles 20, which have large iron loss, are close to each other. As a result, the rotor 3 can suppress iron loss.

The stopper 23 is formed of an insulating material and is engaged with the first salient pole 21 and the second salient pole 22. The insulating material forming the stopper 23 is non-magnetic and insulating, and is, for example, ceramics or a resin material. The stopper 23 engages with two first salient poles 21 and two second salient poles 22 that are in contact with each other in the circumferential direction of the rotor core 10. By configuring the stopper 23 in this way, the second salient pole 22 can be prevented from being separated from the first salient pole 21 even when the centrifugal force from the rotation of the rotor 3 and the magnetic stress act on the second salient pole 22. Hereinafter, the configurations of the first salient pole 21, the second salient pole 22, and the stopper 23 will be described in detail.

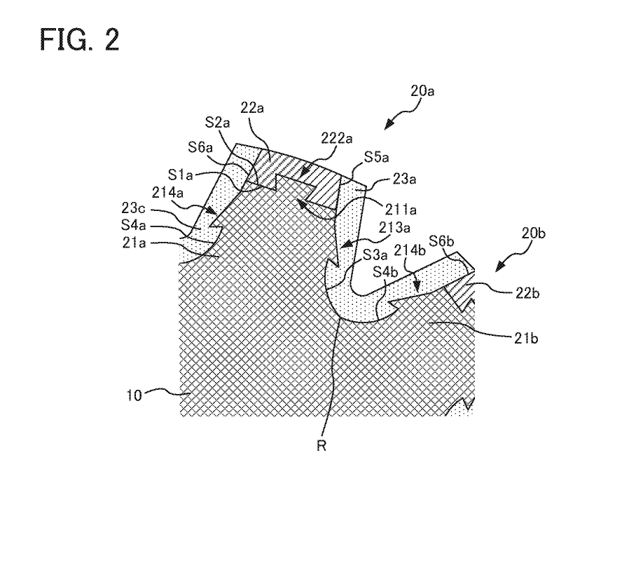

FIG. 2 is an enlarged view of a portion P of the cross-sectional view of the rotor 3 shown in FIG. 1. In the following description, the configuration of a salient pole 20a shown in FIG. 2 among the plurality of salient poles 20 included in the rotor 3 and the configuration of a stopper 23a shown in FIG. 2 among the plurality of stoppers 23 included in the rotor 3 will be mainly described. The configuration of the salient pole 20 different from the salient pole 20a is the same as the configuration of the salient pole 20a, and the configuration of the stopper 23 different from the stopper 23a is the same as the configuration of the stopper 23a.

As shown in FIG. 2, in the first salient pole 21a, a wedge-shaped first convex portion 211a is formed on a surface S1a in contact with the second salient pole 22a. The surface S1a is a top surface of the first salient pole 21a. In the second salient pole 22a, a wedge-shaped concave portion 222a is formed on a surface S2a in contact with the first salient pole 21a, and the concave portion 222a is fitted to the first convex portion 211a. The length of the first convex portion 211a and the length of the concave portion 222a in the circumferential direction of the rotor core 10 are formed to become longer the farther they are from the rotor core 10 in the radial direction. With the above configuration, even when the centrifugal force from the rotation of the rotor 3 and the magnetic stress act on the second salient pole 22, the second salient pole 22 can be made difficult to separate from the first salient pole 21.

In the first salient pole 21a, a wedge-shaped second convex portion is formed on the surface along the radial direction of the rotor core 10, and the stopper 23 is engaged with the second convex portion. Specifically, in the first salient pole 21a, a wedge-shaped second convex portion 213a is formed on a surface S3a, and a wedge-shaped second convex portion 214a is formed on a surface S4a.

The second convex portion 213a is formed to exclude the end portion of the surface S3a in the radial direction of the rotor core 10, and the second convex portion 214a is formed to exclude the end portion of the surface S4a in the radial direction of the rotor core. The farther the second convex portion 213a and the second convex portion 214a are from the top surface of the first salient pole 21, the more they protrude in the circumferential direction of the rotor core 10. The second convex portion 213a and the second convex portion 214a may be formed such that a point (that is, the distal end) that protrudes the most in the circumferential direction of the rotor core 10 is positioned closest to the rotor core 10 in the radial direction.

The stopper 23a is engaged with the second convex portion 213a, and the stopper 23c is engaged with the second convex portion 214a. With the above-described configuration, even when the centrifugal force from the rotation of the rotor 3 and the magnetic stress act on the stopper 23, the stopper 23 can be effectively prevented from dislodging outward in the radial direction of the rotor core 10.

The second salient pole 22a is formed so that the length in the circumferential direction of the rotor core 10 becomes shorter as it becomes farther from the outer peripheral surface of the rotor core 10. Specifically, the second salient pole 22a has a tapered shape. The stopper 23a is engaged with a surface S5a of the second salient pole 22a along the radial direction of the rotor core 10, and the stopper 23c is engaged with a surface S6a of the second salient pole 22a along the radial direction of the rotor core 10. With the above configuration, even when the centrifugal force from the rotation of the rotor 3 and the magnetic stress act on the second salient pole 22, the second salient pole 22 can be effectively prevented from separating from the first salient pole 21.

The stopper 23 is provided to contact (i) two surfaces of adjacent first salient poles 21 that face each other, (ii) two surfaces of adjacent second salient poles 22, which are provided radially outside the first salient poles 21 and face each other, and (iii) the outer peripheral surface between the adjacent first salient poles 21. For example, the two facing surfaces of the adjacent first salient poles 21 are surface S3a of the first salient pole 21a and surface S4b of the first salient pole 21b. The two facing surfaces of the adjacent second salient poles 22 are, for example, surface S5a of the second salient pole 22a and surface S6b of the second salient pole 22b. The outer peripheral surface between the adjacent first salient poles 21 is, for example, an outer peripheral surface R.

As an example, as shown in FIG. 2, the stopper 23a is provided to contact the surface S3a, the surface S4b, the surface S5a, the surface S6b, and the outer peripheral surface R, and has a U-shaped cross section perpendicular to the axial direction of the rotating shaft 2. In the above configuration, the stopper 23a includes concave portions formed on its contact surface with surface S3a and surface S4b. These concave portions are fitted to the second convex portion 213a and a wedge-shaped second convex portion 214b, which is formed on a surface of the first salient pole 21b along the radial direction of the rotor core 10. As a result, even when the centrifugal force from the rotation of the rotor 3 and the magnetic stress act on the stopper 23a, the stopper 23a can be effectively prevented from dislodging outward in the radial direction of the rotor core 10.

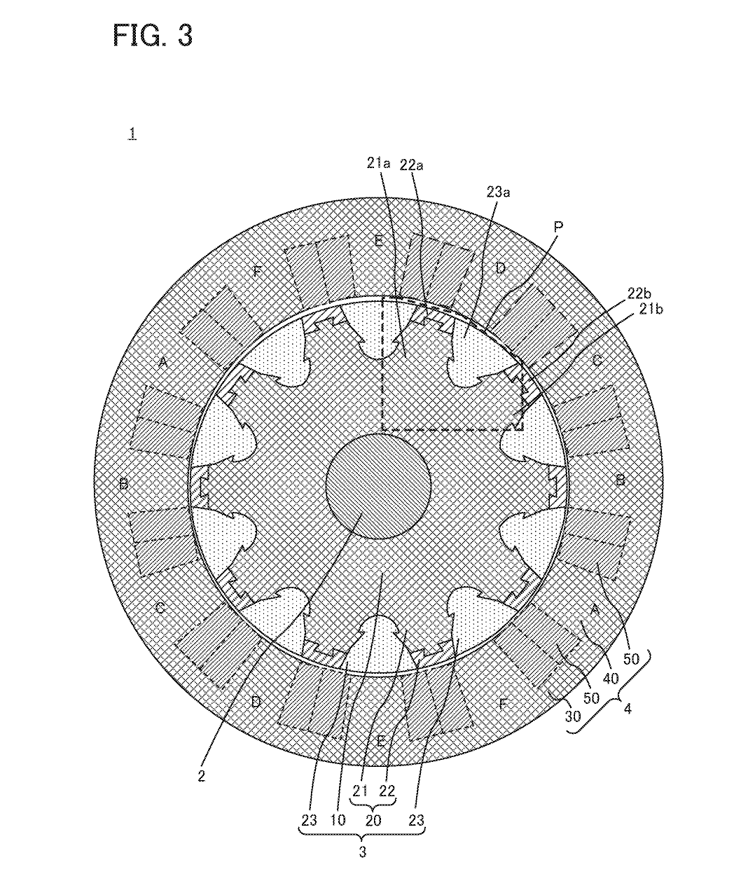

The stopper 23 shown in FIGS. 1 and 2 has a U-shaped cross section perpendicular to the axial direction of the rotating shaft 2, but this configuration is not limiting. The stopper 23 may be configured to fill the space between adjacent first salient poles 21, and the space between adjacent second salient poles 22. FIG. 3 is a view showing a stopper 23 that is configured to fill the space between adjacent salient poles 20. The motor 1 shown in FIG. 3 differs from the motor 1 shown in FIG. 1 in the shape of the stopper 23, while being identical in other respects. As shown in FIG. 3, the stopper 23a may be configured to fill the space between adjacent first salient pole 21a and the first salient pole 21b and the space between the second salient pole 22a and the second salient pole 22b. With this configuration, the rigidity of the stopper 23 is increased, making it easier to form the stopper 23 using an insulating material with low strength.

### First Modification

In the above description, a configuration in which the motor 1 is a 10-salient pole 12-slot SR motor has been exemplified, but the embodiment is not limited thereto. The motor 1 may be an SR motor with a different number of poles and slots, such as an 8-salient pole 12-slot SR motor.

### Second Modification

In the above description, a configuration is exemplified in which the first salient pole 21 has the wedge-shaped convex portion on the surface in contact with the second salient pole 22, and the second salient pole 22 has the wedge-shaped concave portion on the surface in contact with the first salient pole 21, but the embodiment is not limited thereto. The first salient pole 21 may have a wedge-shaped concave portion formed on a surface in contact with the second salient pole 22, and the second salient pole 22 may have a wedge-shaped convex portion formed on a surface in contact with the first salient pole 21. The convex portion of the second salient pole 22 may be fitted into the concave portion of the first salient pole 21. With this configuration, the rotor 3 can have a larger volume of the second salient pole 22, which is formed of a low iron-loss material, than the rotor 3 shown in FIG. 1. As a result, the iron loss generated by rotation of the rotor 3 can be more easily reduced.

### Effect of the rotor 3

As described above, the rotor 3 includes: the rotor core 10 which is rotatably disposed about the rotating shaft 2 and is formed of the first magnetic material; the first salient poles 21 which are formed of the first magnetic material, and are formed on the outer peripheral surface of the rotor core 10 at predetermined intervals in the circumferential direction of the rotor core 10; the second salient poles 22 which are provided radially outside the first salient poles 21 of the rotor core 10 and are formed of the second magnetic material having lower iron loss than the first magnetic material; and the stopper 23 which is formed of the insulating material and is engaged with the first salient poles 21 and the second salient poles 22.

Since the rotor 3 is configured as described above, the second salient poles 22, formed of a low iron-loss material, can be provided at positions where the tooth portions 40 and the salient poles 20 are close to each other, where iron loss is likely to increase, and thus the rotor 3 can suppress iron loss. Furthermore, since the rotor core 10 and the first salient pole 21 can be formed from a conventional material that is lower in cost and has a higher saturation magnetic flux density than a low iron-loss material, it is possible to suppress both an increase in cost and a decreases in torque density. In addition, because the stopper 23 engages with the first salient pole 21 and the second salient pole 22, the second salient pole 22 can be prevented from separating from the first salient pole 21 even when the centrifugal force from the rotation of the rotor 3 and the magnetic stress act on the second salient pole 22.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A rotor comprising:
a rotor core rotatably disposed about a rotating shaft and formed of a first magnetic material;
a plurality of first salient poles formed of the first magnetic material and formed on an outer peripheral surface of the rotor core at predetermined intervals in a circumferential direction of the rotor core;
a plurality of second salient poles provided radially outside the plurality of first salient poles of the rotor core and formed of a second magnetic material having lower iron loss than the first magnetic material; and
a stopper, formed of an insulating material, that is engaged with the first salient poles and the second salient poles.

2. The rotor according to claim 1, wherein a length of the second salient pole in the circumferential direction of the rotor core becomes shorter as a distance from an outer peripheral surface of the rotor core increases, and
the stopper is engaged with a surface of the second salient pole along a radial direction of the rotor core.

3. The rotor according to claim 1, wherein the first salient pole has a first convex portion that is wedge-shaped and is formed on a surface in contact with the second salient pole,
the second salient pole has a concave portion that is wedge-shaped and is formed on a surface in contact with the first salient pole, and
the concave portion of the second salient pole is fitted to the first convex portion of the first salient pole.

4. The rotor according to claim 1, wherein the first salient pole has a concave portion that is wedge-shaped and is formed on a surface in contact with the second salient pole,
the second salient pole has a first convex portion that is wedge-shaped and is formed on a surface in contact with the first salient pole, and
the first convex portion of the second salient pole is fitted to the concave portion of the first salient pole.

5. The rotor according to claim 1, wherein the stopper is provided to contact (i) two opposing surfaces of adjacent ones of the first salient poles, (ii) two opposing surfaces of adjacent ones of the second salient poles, which are provided radially outside the first salient poles, and (iii) an outer peripheral surface between the adjacent first salient poles.

6. The rotor according to claim 5, wherein the stopper fills a space between the adjacent first salient poles and a space between the adjacent second salient poles.

7. The rotor according to claim 1, wherein, in the first salient pole, a wedge-shaped second convex portion is formed on a surface along a radial direction of the rotor core, and
the stopper is engaged with the second convex portion.

8. The rotor according to claim 7, wherein the farther the second convex portion is from a top surface of the first salient pole, the more the second convex portion protrudes in a circumferential direction of the rotor core, and is formed so that a point that protrudes the most in the circumferential direction of the rotor core is positioned closest to the rotor core.

9. The rotor according to claim 3, wherein a length of the first convex portion and a length of the concave portion in the circumferential direction of the rotor core are formed to increase as the first convex portion and the concave portion are farther from the rotor core.

10. A switched reluctance motor comprising:
a rotor; and
a stator, wherein
the rotor includes:
a rotor core rotatably disposed about a rotating shaft and formed of a first magnetic material;
a plurality of first salient poles formed of the first magnetic material and formed on an outer peripheral surface of the rotor core at a predetermined first interval in a circumferential direction of the rotor core;
a plurality of second salient poles provided radially outside the plurality of first salient poles of the rotor core and formed of a second magnetic material having lower iron loss than the first magnetic material; and
a stopper, formed of an insulating material, that is engaged with the first salient poles and the second salient poles, and
the stator includes:
a stator core disposed on an outer diameter side of the rotor; and
tooth portions that are formed on an inner peripheral surface of the stator core at a predetermined second interval in the circumferential direction of the stator core, each of the tooth portions having a coil of one phase among coils of a plurality of phases wound therearound.
